(19) United States
(12) Patent Application Publication
(10) Pub. No.: US 2026/0147401 A1
(43) Pub. Date: May 28, 2026

(54) DYNAMIC OPERATING SYSTEM LEVEL CAPABILITIES GOVERNED BY ENERGY CONSUMPTION

(71) Applicant: Red Hat, Inc., Raleigh, NC (US)

(72) Inventors: Leigh Griffin, Waterford (IE); Leonardo Rossetti, Sao Paulo (BR)

(21) Appl. No.: 18/959,179

(22) Filed: Nov. 25, 2024

(51) Int. Cl. G06F 1/3287

(52) U.S. Cl. CPC G06F 1/3287

(57) ABSTRACT

Aspects of the present disclosure relate to dynamically configuring OS component capabilities based on energy consumption. More specifically, a method of the present disclosure includes generating a first map of information based on source code, where the first map of information comprises a function call tree of an OS component associated with the source code and energy usage of a host device of the OS component. The method includes generating a second map of information based on the source code, the second map of information indicating energy usage of active applications and active component loads in view of energy availability of the host device of the OS component. The method includes determining whether to activate or deactivate the OS component based on the energy availability of the host device, the first map of information, and the second map of information.

### TECHNICAL FIELD

Aspects of the present disclosure relate to energy consumption of operating system (OS) components, and more particularly, to dynamically configuring OS component capabilities based on energy consumption.

### BACKGROUND

Managing energy consumption in devices may be challenging, particularly on edge devices (e.g., Internet of Things (IoT) devices) where such devices may have finite power (e.g., battery power), and may run out of power. If devices run out of power, the system that services such devices is unable to provide such services. In addition, with the rise of generative artificial intelligence, the cost of operating the processors at data centers can be costly and energy consumption may govern the viability of devices in the future. Energy management systems may reduce power consumption and improve usage of available energy, which may provide a cost saving in power consumption and result in efficient use of available energy sources.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example system in accordance with some aspects of the present disclosure.

FIG. 2 is a block diagram that illustrates dynamically configuring OS component capabilities in accordance with some aspects of the present disclosure.

FIG. 3 is a block diagram that illustrates an example system in accordance with some aspects of the present disclosure.

FIG. 4 is a flow diagram of a method for dynamically configuring OS component capabilities in accordance with some aspects of the present disclosure.

FIG. 5 is a block diagram of an example of a computer system that may perform one or more of the operations described herein in accordance with some aspects of the present disclosure.

### DETAILED DESCRIPTION

Operating systems may run multiple components in an active or semi-active state, regardless of the immediate need of the multiple components. Operating the multiple components in the active or semi-active state regardless of the immediate need of such components may lead to unnecessary energy consumption and may be significant in devices where energy resources may be limited, such as but not limited to electric vehicles, IoT devices, or data centers where energy costs can be substantial. The managing of energy consumption has been evaluated and researched in order to improve efficiency of energy consumption. However, research and investment on energy consumption is at the application level, and not at the component level. It would be desirable to adapt computing processes, at the component level, to leverage the increasing availability of green energy resources in an efficient matter to enhance energy efficiency and environmental sustainability.

The present disclosure addresses the above-noted and other deficiencies by using a processing device to dynamically configure OS component capabilities based on energy consumption. In an example, the processing device generates a first map of information based on a source code, where the first map of information comprises a function call tree of at least one OS component associated with the source code. The processing device generates a second map of information including active applications and active component loads. The processing device determines whether to activate or deactivate the at least one OS component based on a control mechanism, wherein the control mechanism is based on energy availability.

The present disclosure provides for various technical advantages. For example, vis-á-vis generating a first map of information based on a source code, where the first map of information comprises a function call tree of at least one OS component associated with the source code, generating a second map of information including active applications and active component loads, and determining whether to activate or deactivate the at least one OS component based on a control mechanism, where the control mechanism is based on energy availability, may conserve computing resources (e.g., memory usage, processor clock cycles, network bandwidth, etc.) or energy resources (e.g., battery life, energy availability) by dynamically deactivating or activating OS components to reduce or minimize unnecessary energy consumption.

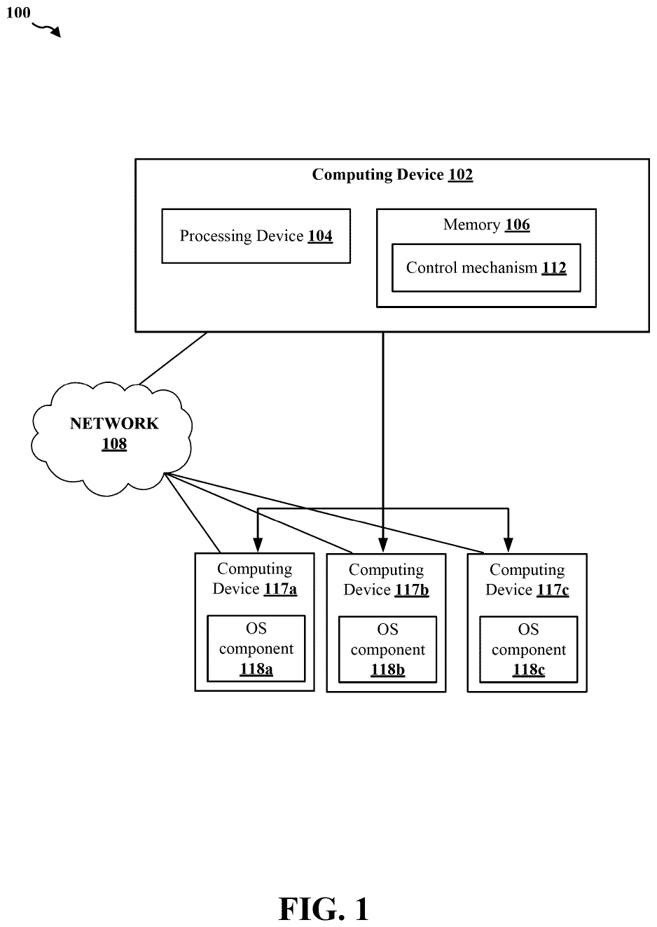

FIG. 1 is a block diagram that illustrates an example system in accordance with some aspects of the present disclosure. As illustrated in FIG. 1, the system 100 includes a computing device 102, processing device 104, memory 106, and a network 108. The computing device 102 may include hardware such as a processing device 104 (e.g., processors, central processing units (CPUs)), memory 106 (e.g., random access memory (RAM), storage devices (e.g., a hard-disk drive (HDD)), and solid-state drives (SSD), etc.), and other hardware devices (e.g., a sound card, video card, etc.). A storage device may include a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The processing device 104 may be operatively coupled to the memory 106.

The computing device 102 may communicate with other computing devices (e.g., computing device 117a, 117b, 117c) that include an OS component (e.g., OS component 118a, 118b, 118c) via a network 108. The network may be a public network (e.g., the internet), a private network (e.g., a local area network (LAN) or wide area network (WAN)), or a combination thereof. In one example, the network may include a wired or a wireless infrastructure, which may be provided by one or more wireless communications systems, such as a WiFi™ hotspot connected with the network and/or a wireless carrier system that can be implemented using various data processing equipment, communication towers (e.g., cell towers), etc. The network 108 may carry communications (e.g., data, message, packets, frames, etc.) between the computing device 102 and the other devices. The computing device 102 may also include one or more sensors (e.g., temperature sensors, moisture sensors, etc.). The computing device may include hardware such as a processing device 104 (e.g., processors, central processing units (CPUs)), memory 106 (e.g., random access memory (RAM), storage devices (e.g., a hard-disk drive (HDD)), and solid-state drives (SSD), etc.), and other hardware devices (e.g., a sound card, a video card, etc.). A storage device may include a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

In some aspects, the computing device 102 may comprise any suitable type of computing device or machine that has a programmable processor (e.g., processing device 104) including, for example, server computers, desktop computers, laptop computers, tablet computers, smartphones, set-top boxes, etc. In some examples, the computing device 102 may include a single machine or may include multiple interconnected machines (e.g., multiple servers configured in a cluster). The computing device 102 may be implemented by a common entity/organization or may be implemented by different entities/organizations. The computing device 102 may execute or include an OS. The OS may manage the execution of other components (e.g., software, applications, etc.) and/or may manage access to the hardware (e.g., processors, memory, storage devices etc.) of a device in the computing device 102.

The computing device 102 may include any suitable type of computing device or machine that has a programmable processor (e.g., processing device 104) including, for example, server computers, desktop computers, laptop computers, tablet computers, smartphones, set-top boxes, etc. In some examples, the computing device 102 may include a single machine or may include multiple interconnected machines (e.g., multiple servers configured in a cluster). The computing device 102 may be implemented by a common entity/organization or may be implemented by different entities/organizations. The computing device 102 may each execute or include an OS, as discussed in more detail below. The OS of computing device 102 may manage the execution of other components (e.g., software, applications, etc.) and/or may manage access to the hardware (e.g., processors, memory, storage devices etc.) of the computing device 102.

The computing device 102 may further include a control mechanism 112. The control mechanism 112 may include instructions for other devices or OS components (e.g., OS components 118a, 118b, 118c) to activate or deactivate based on energy consumption. The computing device 102 may provide activation or deactivation instructions to the other devices via the network 108. One or more OS components (e.g., OS components 118a, 118b, 118c) may be configured to change their power usage based on energy availability. For example, the control mechanism 112 may monitor energy consumption of the one or more OS components (e.g., OS components 118a, 118b, 118c) and determine whether to alter the energy usage of the one or more OS components based, in part, on current energy availability, energy source types (e.g., green energy, traditional power sources), and energy costs. The control mechanism 112 may determine to shutdown or reduce energy usage of the one or more OS components for a period of time.

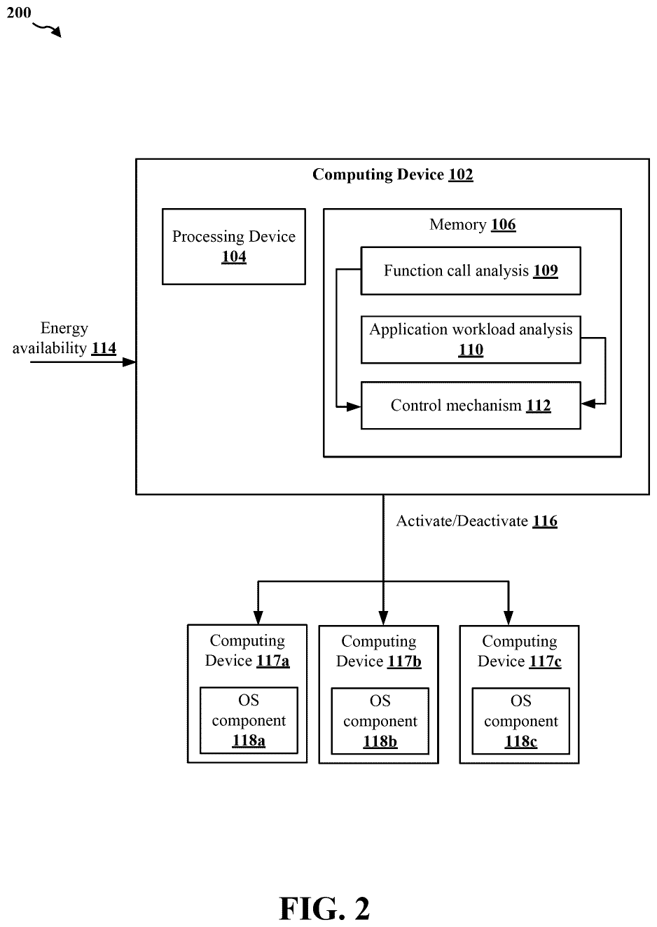

FIG. 2 is a block diagram 200 that illustrates the example system 100 of FIG. 1 in accordance with some aspects of the present disclosure. In the example depicted in FIG. 2, the computing device 102 may be configured to continuously monitor energy consumption of individual OS components (e.g., 118a, 118b, 118c) of other computing devices (e.g., computing device 117a, 117b, 117c) in real-time. For example, the processing device 104 may perform a function call analysis 109 that obtains function call trees and analyses the source code to generate a tree of information. The tree of information may include a map of function calls and relevant parts of a kernel of an underlying OS that drive the one or more OS components (e.g., 118a, 118b, 118c). The tree of information may further include dependencies and the relationships that may exist between different functions from a dependency perspective. The tree of information may include information related to the one or more OS components (e.g., 118a, 118b, 118c), such as but not limited to, the associated applications, a port the OS component may be running on, an amount of memory utilized by the OS component, CPU usage by the OS component, or the like. The tree of information is a description of all the relevant information from the function tree calls, the source code that is driving the one or more OS component, and the various dependencies and responsibilities related to the one or more OS components. The tree of information obtained from the function call analysis 109 may be inputted as a data point for the control mechanism 112. The function call analysis 109 is a kernel level analysis, and the processing device 104 may also perform an application workload analysis 110 that is an application level analysis.

The application workload analysis 110 may generate a map of information of the application that is being driven by a particular process in a particular kernel functionality. The map of information generated by the processing device 104 performing the application workload analysis 110 may be based on the application and the one or more components that are active. The map of information generated by the processing device 104 performing the application workload analysis 110 may be inputted as another data point for the control mechanism 112.

The control mechanism 112 may determine whether to alter the energy consumption of the one or more OS components based on the input from the function call analysis 109, the application workload analysis 110, and energy availability 114. The control mechanism 112 may base the determination to alter the energy consumption (e.g., activate, deactivate, low-power mode, etc.) the one or more components (e.g., 118a, 118b, 118c) based on a threshold and in view of current energy availability, energy source types (e.g., green energy, traditional energy sources, etc.), and energy costs. The control mechanism 112 through comparing the data from the function call analysis 109 and the application workload analysis 110 may determine to shutdown services and/or the one or more OS components for a period of time. A signal with instructions to activate/deactivate 116 may be provided to the one or more OS components (e.g., 118a, 118b, 118c) based on the function call analysis 109, application workload analysis 110, or the energy availability 114 entered into the control mechanism 112. For example, the one or more OS components may be deactivated when energy consumption of the one or more OS components exceeds a threshold associated with energy availability. In another example, the one or more OS components may be activated when energy consumption of the one or more OS components does not exceed the threshold associated with energy availability. In some aspects, the energy availability may comprise solar energy, battery power, or static power. In some aspects, the energy availability may be based on at least one of the solar energy, battery power, static power, or a combination thereof.

In some aspects, the control mechanism 112 may utilize predictive analytics to forecast a number of eventualities. For example, control mechanism 112 may utilize historical information of energy consumption of the one or more OS components to forecast future energy consumption of the one or more OS components. In some aspects, the predictive analytics may allow the control mechanism 112 to preemptively adjust the configuration of the one or more OS components for optimal efficiency. For example, the control mechanism 112 may utilize predictive analytics to forecast a more favorable energy usage of available energy sources based, in part, on historical energy usage (e.g., peak energy time periods, off-peak energy time periods). In some aspects, such as during periods of high green energy availability or low energy costs, the control mechanism 112 may activate additional OS components or increase performance thresholds due, in part, to the energy availability or the reduction of energy costs. In some aspects, such as during periods of low energy availability or high energy costs, the control mechanism 112 may deactivate one or more OS components that may be determined as non-essential or may place the one or more OS components in a low or reduced power mode to preserve energy without significant impacts on user experience or critical system functions.

In some aspects, the one or more OS components may be associated with different services. For example, the one or more OS components may be associated with indexing services, task schedulers, graphical enhancements, unused hardware based on port/driver usage, logging and monitoring which is data intensive, CPU core deactivation, voltage scaling, etc. or the like.

The aspects disclosed herein discuss energy consumption as a non-limiting example, such that capabilities of the operating system may be determined or adjusted based on energy consumption. However, the disclosure is not intended to be limited to the aspects discussed herein and may be applicable to any compute resource, such as but not limited to CPU, memory, disk input/output (I/O), network I/O, or the like.

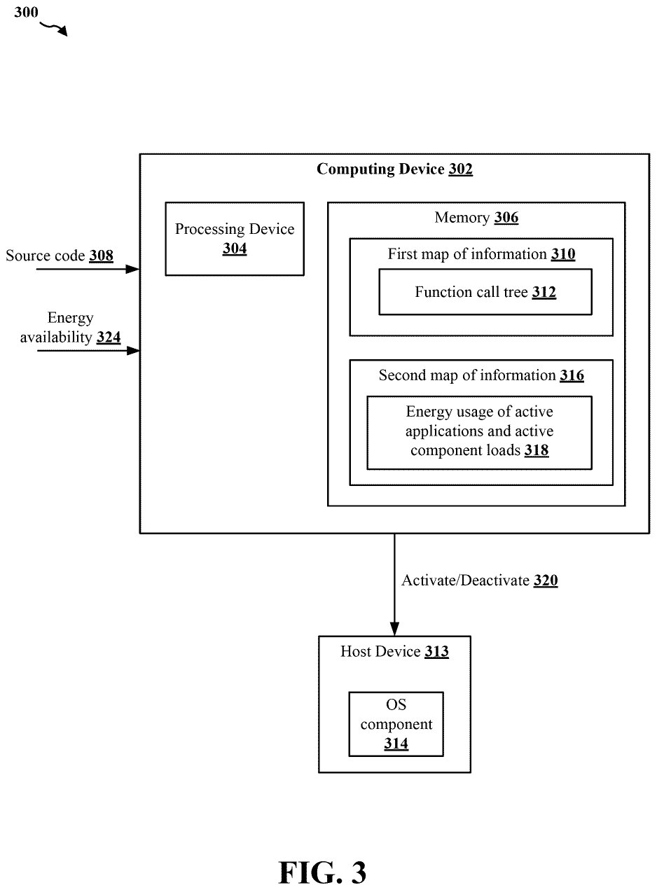

FIG. 3 is a block diagram 300 that illustrates an example system in accordance with some aspects of the present disclosure. The system includes a computing device 302. The computing device 302 includes a processing device 304 and a memory 306. The processing device 304 is operatively coupled to the memory 306.

The processing device 304 is to generate a first map of information 310 based on source code 308, where the first map of information 310 comprises a function call tree 312 of at least one OS component 314 associated with the source code 308. The first map of information 310 may indicate energy usage of a host device 313 of the at least one OS component 314. The processing device 304 is to generate a second map of information 316 based on the source code 308, the second map of information may indicate energy usage of active applications and active component loads in view of energy availability 324 of the host device 313 of the at least one OS component 314. The processing device 304 determines whether to activate/deactivate 320 the at least one OS component 314 based on energy availability 324 of the host device 313, the first map of information 310, and the second map of information 316.

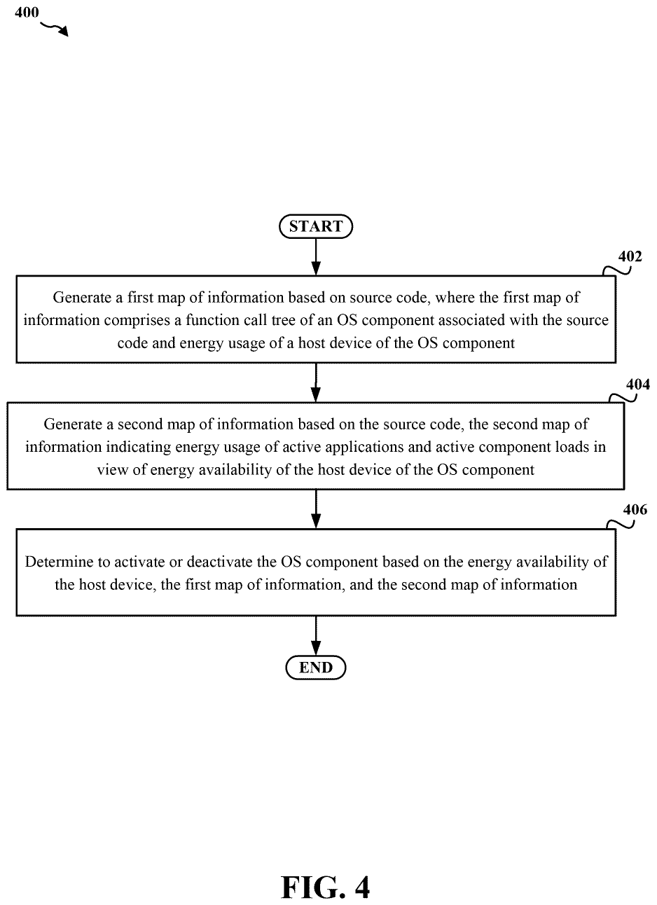

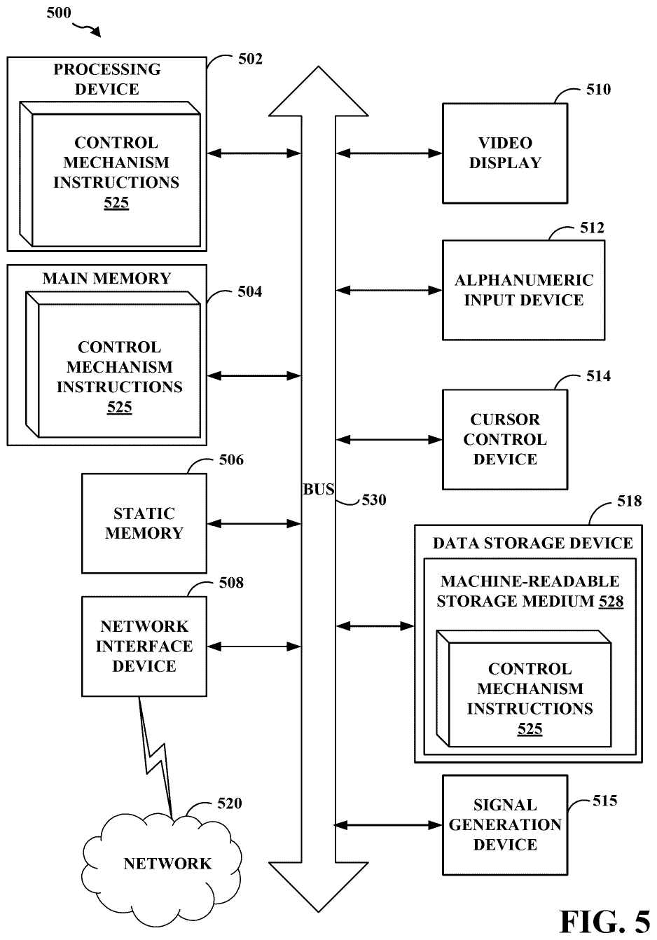

FIG. 4 is a flow diagram of a method 400 for dynamically configuring OS component capabilities based on energy consumption in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed by a computing device (e.g., computing device 102 in FIGS. 1 and 2, a computing device 302 in FIG. 3, the computer system 500 in FIG. 5, etc.).

At block 402, a processing device generates a first map of information based on source code, where the first map of information comprises a function call tree of at least one OS component associated with the source code. For example, the first map of information may be or include function call analysis 109 or first map of information 310. In an example, the at least one OS component may be or include OS component 118a, 118b, 118c, or 314. In an example, the function call tree may be or include function call tree 312. In an example, the source code may be or include source code 308. The first map of information may include information of energy usage of a host device of the OS component.

At block 404, the processing device generates a second map of information based on the source code including active applications and active component loads, where the second map of information indicates energy usage of the active applications and active component loads in view of energy availability of the host device of the OS component. For example, the second map of information may be or include application workload analysis 110 or second map of information 316. In an example, information including active applications and active component loads may be or include application workload analysis 110 or information including active applications and active component loads 318.

At block 406, the processing device determines whether to activate or deactivate the at least one OS component based on a control mechanism, where a determination to activate or deactivate by the control mechanism is based on the energy availability of the host device, the first map of information, and the second map of information. For example, to activate or deactivate the at least one OS component may be or include activate/deactivate 116 or 320. In an example, the control mechanism may be or include control mechanism 322.

In some aspects, to determine whether to activate or deactivate the at least one OS component, the processing device compares the first map of information and the second map of information, where the control mechanism compares energy usage indicated by the first map of information and the energy usage of the active applications and the active component loads indicated by the second map of information. The first map of information may include information directed to an OS level, where the second map of information includes information directed to an application level. The control mechanism determines to activate or deactivate the OS component based on a comparison of energy usage at the OS level and the application level. In some aspects, the first map of information includes portions of the source code that correspond to the at least one OS component.

In some aspects, the processing device monitors energy consumption of each sub-component of the at least one OS component associated with the source code, the active applications, and the active component loads.

In some aspects, the OS component may be activated or deactivated by a predictive element. For example, the control mechanism may comprise a predictive element, where the at least one OS component is activated or deactivated based on the predictive element. For example, the predictive element may forecast or predict peak usage time or non-peak usage time of energy based on historical information, environmental information, operational information, or the like, and adjust energy usage of the at least one OS component accordingly. In some aspects, the at least one OS component is configured to enter a reduced power mode, in response to a determination to deactivate, such that the at least one OS component in the reduced power mode operates using limited resources and/or power.

FIG. 5 illustrates a diagrammatic representation of a machine in the example form of a computer system 500 within which a set of instructions, for causing the machine to perform any one or more of the methodologies discussed herein for dynamically configuring OS component capabilities based on energy consumption. More specifically, the machine may generate a first map of information based on source code, wherein the first map of information comprises a function call tree of at least one OS component associated with the source code and energy usage of a host device of the at least one OS component; generate a second map of information based on the source code, the second map of information indicating energy usage of active applications and active component loads in view of energy availability of the host device of the at least one OS component; and determine whether to activate or deactivate the at least one OS component based on the energy availability of the host device, the first map of information, and the second map of information.

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with control mechanism instructions 525, for performing the operations and steps discussed herein. For example, the control mechanism instructions 525 may include instructions for dynamically configuring OS component capabilities based on energy consumption.

The data storage device 518 may include a machine-readable storage medium 528 storing control mechanism instructions 525 (e.g., software) embodying any one or more of the methodologies of functions described herein. The control mechanism instructions 525 may also reside, completely or partially, within the main memory 504 or within the processing device 502 during execution thereof by the computer system 500; the main memory 504 and the processing device 502 also constituting machine-readable storage media. The control mechanism instructions 525 may further be transmitted or received over the network 520 via the network interface device 508.

The machine-readable storage medium 528 may also be used to store the control mechanism instructions 525 to perform a method for dynamically configuring OS component capabilities based on energy consumption, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “generating,” “determining,” “comparing,” “monitoring,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
generating a first map of information based on source code, wherein the first map of information comprises a function call tree of an operating system (OS) component associated with the source code and energy usage of a host device of the OS component;
generating a second map of information based on the source code, the second map of information indicating energy usage of active applications and active component loads in view of energy availability of the host device of the OS component; and
determining, by a processing device, whether to activate or deactivate the OS component based on the energy availability of the host device, the first map of information, and the second map of information.

2. The method of claim 1, wherein the determining whether to activate or deactivate the OS component comprises:
comparing the energy usage indicated by the first map of information and the energy usage of the active applications and the active component loads indicated by the second map of information.

3. The method of claim 1, wherein the first map of information includes information at an OS level, wherein the second map of information includes information at an application level, wherein the determining to activate or deactivate the OS component is based on a comparison of energy usage at the OS level and the application level.

4. The method of claim 1, wherein the first map of information includes portions of the source code that correspond to the OS component.

5. The method of claim 1, further comprising:
monitoring energy consumption of each sub-component of the OS component associated with the source code, the active applications, and the active component loads.

6. The method of claim 1, wherein the OS component is activated or deactivated by a predictive element.

7. The method of claim 1, wherein the OS component is configured to enter a reduced power mode, in response to the determination to deactivate, wherein the OS component in the reduced power mode operates using limited resources.

8. A system, comprising:
a memory; and
a processing device, operatively coupled to the memory, to:
generate a first map of information based on source code, wherein the first map of information comprises a function call tree of an operating system (OS) component associated with the source code and energy usage of a host device of the OS component;
generate a second map of information based on the source code, the second map of information indicating energy usage of active applications and active component loads in view of energy availability of the host device of the OS component; and
determine whether to activate or deactivate the OS component based on the energy availability of the host device, the first map of information, and the second map of information.

9. The system of claim 8, wherein to determine whether to activate or deactivate the OS component, the processing device is to:
compare the energy usage indicated by the first map of information and the energy usage of the active applications and the active component loads indicated by the second map of information.

10. The system of claim 8, wherein the first map of information includes information at an OS level, wherein the second map of information includes information at an application level, wherein the determining to activate or deactivate the OS component is based on a comparison of energy usage at the OS level and the application level.

11. The system of claim 8, wherein the first map of information includes portions of the source code that correspond to the OS component.

12. The system of claim 8, wherein the processing device is to:
monitor energy consumption of each sub-component of the OS component associated with the source code, the active applications, and the active component loads.

13. The system of claim 8, wherein the OS component is activated or deactivated by a predictive element.

14. The system of claim 8, wherein the OS component is configured to enter a reduced power mode, in response to the determination to deactivate, wherein the OS component in the reduced power mode operates using limited resources.

15. A non-transitory computer-readable medium having instructions stored thereon which, when executed by a processing device, cause the processing device to:
generate a first map of information based on source code, wherein the first map of information comprises a function call tree of an operating system (OS) component associated with the source code and energy usage of a host device of the OS component;
generate a second map of information based on the source code, the second map of information indicating energy usage of active applications and active component loads in view of energy availability of the host device of the OS component; and
determine, by the processing device, whether to activate or deactivate the OS component based on the energy availability of the host device, the first map of information, and the second map of information.

16. The non-transitory computer-readable medium of claim 15, wherein to determine whether to activate or deactivate the OS component, the instructions, when executed by the processing device, cause the processing device is to compare the energy usage indicated by the first map of information and the energy usage of the active applications and the active component loads indicated by the second map of information.

17. The non-transitory computer-readable medium of claim 15, wherein the first map of information includes information at an OS level, wherein the second map of information includes information at an application level, wherein the determining to activate or deactivate the OS component is based on a comparison of energy usage at the OS level and the application level.

18. The non-transitory computer-readable medium of claim 15, wherein the first map of information includes portions of the source code that correspond to the OS component.

19. The non-transitory computer-readable medium of claim 15, wherein the instructions, when executed by the processing device, cause the processing device to monitor energy consumption of each sub-component of the OS component associated with the source code, the active applications, and the active component loads.

20. The non-transitory computer-readable medium of claim 15, wherein the OS component is activated or deactivated by a predictive element.
